(19) United States
(12) Patent Application Publication
(10) Pub. No.: US 2014/0272208 A1
(43) Pub. Date: Sep. 18, 2014

(54) VACUUM GLASS PANEL HAVING GETTER FILLER AND METHOD OF MANUFACTURING SAME

(71) Applicant: LG HAUSYS, LTD., Seoul (KR)

(72) Inventors: Su-Bin Song, Uiwang-si (KR); Beom-Goo Son, Suwon-si (KR); Soon-Ho Kwon, Ulsan (KR); Youn-Ki Jun, Gwacheon-si (KR)

(73) Assignee: LG Hausys, Ltd., Seoul (KR)

(21) Appl. No.: 14/355,947

(22) PCT Filed: Nov. 16, 2012
(86) PCT No.: PCT/KR2012/009717

§ 371 Date: May 2, 2014

(30) Foreign Application Priority Data
Nov. 16, 2011 (KR) 10-2011-0119294

(51) Int. Cl. E06B 3/663; E06B 3/673

(52) U.S. Cl. CPC E06B 3/66304; E06B 3/67326
USPC 428/34; 156/109

(57) ABSTRACT

A vacuum glass panel having a getter filler that includes a plurality of fillers having getter functions without the need for a separate getter, thus reducing costs and enhancing durability, and to a method of manufacturing same. The vacuum glass panel according to the present invention includes: an upper glass plate; a lower glass plate facing the upper glass plate; a sealing portion that is formed along the edges of the upper and lower glass plates and seals the upper and lower glass plates so that a vacuum layer is formed in the space between the upper and lower glass plates; and at least one getter filler that is placed in the vacuum layer, keeps the gap between the upper and lower glass plates constant, and suctions gas from the vacuum layer.

### TECHNICAL FIELD

The present invention relates to a vacuum glass panel and a method of manufacturing the same. Particularly, the present invention relates to a vacuum glass panel, which includes a plurality of fillers having getter functions without using separate getters, thereby reducing manufacturing costs while improving durability, and a method of manufacturing the same.

### BACKGROUND ART

Energy consumption for buildings occupies 25% of total domestic energy consumption, and energy loss through windows approaches about 35% of total building energy consumption.

Such energy consumption is caused by the fact that windows have a coefficient of overall heat transmission about 2˜5 times higher than those of walls or roofs, and such windows are most vulnerable part of an outer surface of a building in terms of heat insulation.

Generally, a window is divided into a frame and a glass section, and discharge of thermal energy through the window generally occurs through the glass section, which occupies most of the area of the window. Thus, it is an urgent issue to achieve significant reduction of heat loss through the glass section.

In view of this, various studies have been made to develop high insulation windows having a coefficient of overall heat transmission similar to that of walls, as disclosed in Korean Patent Registration No. 10-0253882 (Jan. 27, 2000).

To this end, a vacuum glass panel has been spotlighted in the art. The vacuum glass panel includes two glass panes coupled to each other and a vacuum layer formed therebetween to minimize heat loss due to thermal conduction and convection. Vacuum degree of the vacuum layer is a main factor determining insulation performance of the vacuum glass panel.

A vacuum glass panel generally has a vacuum degree of 10⁻³ to 10⁻⁴ Torr, and employs a getter, for example, an evaporation type barium getter, for adsorbing remaining gas in the vacuum layer in order to maintain such a vacuum degree.

The evaporation type barium getter exhibits excellent performance in adsorption of remaining gas immediately after activation, and allows determination as to formation of the vacuum layer based on an initial deposition state of barium. However, the evaporation type barium getter has a great thickness and thus requires a separate process for forming a getter groove on the pane and heating to a temperature of 800° C. or more for activation.

As a result, conventional techniques have drawbacks, such as failure due to local heating for activation or processing of the getter groove for the evaporation type barium getter, long process time, and the like.

### DISCLOSURE

### Technical Problem

It is one aspect of the present invention to provide a vacuum glass panel, which includes a plurality of fillers having getter functions without using a separate getter, thereby improving durability.

It is another aspect of the present invention to provide a method for manufacturing a vacuum glass panel, which includes a plurality of fillers having getter functions without using a separate getter, thereby reducing manufacturing costs while improving durability.

### Technical Solution

In accordance with one aspect of the present invention, a vacuum glass panel includes an upper glass pane; a lower glass pane facing the upper glass pane; a sealing portion formed along edges of the upper and lower glass panes and sealing a space between the upper and lower glass panes to form a vacuum layer in the space between the upper and lower glass panes; and at least one getter filler disposed in the vacuum layer to maintain a gap having a constant thickness between the upper and lower glass panes and adsorbing gas in the vacuum layer.

In the vacuum glass panel according to the invention, the getter filler may include Zr as a gas adsorption material.

In the vacuum glass panel according to the invention, the getter filler may include a Zr alloy comprising Zr and at least one metal selected from among Al, Fe, and Ti. Here, Zr may be present in an amount of 70 to 90 parts by weight based on 100 parts by weight of the Zr alloy.

In the vacuum glass panel according to the invention, the getter fillers may have a polyhedral shape including bosses and depressions formed along a side surface thereof, and may be disposed in a matrix arrangement.

In the vacuum glass panel according to the invention, the getter filler may have heat resistance to maintain a shape thereof at 500° C. and a compressive strength of greater than 5000 kg/cm².

In accordance with another aspect of the invention, a method for manufacturing a vacuum glass panel includes: preparing an upper glass pane and a lower glass pane; depositing a sealing material along an edge of the lower glass pane within a vacuum chamber to form a sealing portion; placing a plurality of getter fillers on an upper surface of the lower glass pane; and assembling the upper and lower glass panes so as to face each other by placing the upper glass pane on the lower glass pane, followed by heating.

In the method according to the invention, the placing a plurality of getter fillers may include carrying the getter fillers using an adsorption nozzle to place the getter fillers on an upper surface of the lower glass pane.

In the method according to the invention, the assembling the upper and lower glass panes so as to face each other may include heating an overall surface of the upper glass pane to activate the getter fillers.

### Advantageous Effects

According to the invention, the vacuum glass panel is provided with a plurality of fillers having getter functions without using a separate getter, thereby reducing manufacturing costs while improving durability.

The vacuum glass panel according to the present invention may have improved gas adsorption capabilities through the getter fillers having bosses and depressions formed on side surfaces thereof.

In the method for manufacturing a vacuum glass panel according to the invention, the getter fillers are activated in the course of fusing the upper and lower glass panes disposed to face each other, without a process for activating separate getters used in the related art, thereby reducing process time and manufacturing costs for the vacuum glass panel.

### DESCRIPTION OF DRAWINGS

FIG. 1a is a plan view of a vacuum glass panel according to one embodiment of the present invention.

FIG. 1b is a sectional view taken along line A-A of FIG. 1.

FIG. 2 is a perspective view of a getter filler provided to a vacuum glass panel according to one embodiment of the present invention.

FIG. 3 is a perspective view of a getter filler according to another embodiment of the present invention.

FIG. 4 is a flowchart of a method for manufacturing a vacuum glass panel including getter fillers according to one embodiment of the present invention.

### BEST MODE

Embodiments of the present invention will be described in more detail with reference to the accompanying drawings. It should be understood that the present invention is not limited to the following embodiments and may be embodied in different ways. The scope of the present invention is defined only by the claims.

Referring to FIGS. 1a and 1b, according to one embodiment of the invention, a vacuum glass panel 100 includes an upper glass pane 110, a lower glass pane 120, a sealing material 130, and getter fillers 150.

The upper and lower glass panes 110, 120 are disposed to face each other in parallel and are separated from each other. The upper and lower glass panes 110, 120 have a plate shape and may be designed to have the same area.

The sealing portion 130 is formed along edges of the upper and lower glass panes 110, 120 using glass frits, and seals a gap between the upper and lower glass panes 110, 120 such that a vacuum layer (V) is formed between the upper and lower glass panes 110, 120. As a result, the upper glass pane 110 and the lower glass pane 120 are assembled to face each other by the sealing material 130.

The getter fillers 150 are disposed in the vacuum layer (V) between the upper glass pane 110 and the lower glass pane 120 to maintain the gap between the upper glass pane 110 and the lower glass pane 120 to a predetermined distance (g), and acts as getters for adsorbing gas remaining or generated in the vacuum layer (V).

The vacuum glass panel includes one or more getter fillers 150 in the vacuum layer (V), and such fillers may be disposed in a matrix arrangement in plan view, as shown in FIG. 1a.

Such arrangement of the getter fillers 150 is provided to maintain a constant thickness of the vacuum layer (V) and is designed to reduce stress generated around the getter fillers 150 by a vacuum to long-term allowable stress or less of a glass material.

Particularly, according to the invention, the getter fillers 150 include Zr as a gas adsorption material. Although various metals such as Ta, Cb, Zr, Th, Mg, Ba, Ti, Al. Nb, Fe, Pt, Au, and the like are known as gas adsorption materials in the art, Zr is advantageous in terms of processing conditions and economic feasibility of the vacuum glass panel according to the present invention.

Further, in the vacuum glass panel according to the present invention, the Zr getter fillers 150 may be prepared by alloying with other metals in order to reduce activation temperature. Particularly, considering a temperature range in a current process of manufacturing a vacuum glass panel, the fillers may be formed of Zr alloys including at least one of Al, Fe, and Ti, wherein Zr is preferably present in an amount of 70 parts by weight to 90 parts by weight, particularly 80 parts by weight to 90 parts by weight, based on 100 parts by weight of the Zr alloy. If the Zr content of the filler is less than this range, the fillers have deteriorated adsorption capability, and if the Zr content exceeds this range, there is a problem of increase in getter activation temperature. If the side sealing temperature of the vacuum glass panel is lowered, various Zr alloys including various metals in addition to the aforementioned metals may be used.

The getter filler 150 may be obtained by punching or etching a sheet including the Zr alloy and having a thickness of 0.1 mm to 0.3 mm.

The getter filler 150 may have a cylindrical shape, a side surface of which is formed with bosses and depressions, as shown in FIG. 2, or may have a hexahedral shape, side surfaces of which are formed with bosses and depressions, as shown in FIG. 3. Here, although not shown in detail, the getter filler 150 may have other shapes including an octahedral shape, a dodecahedral shape, and the like.

In this way, the getter filler 150 having a hexahedral or cylindrical shape and formed with bosses and depressions on side surfaces thereof may have a length (L) of 0.4 mm to 0.6 mm and a height (h) of 0.1 mm to 0.3 mm. The side surface of the getter filler formed with bosses and depressions thereon has an enlarged contact area reacting with gas, thereby improving gas adsorption efficiency.

If the length (L) of the getter filler 150 is less than 0.4 mm, the getter filler 150 can be damaged by load of the upper or lower glass pane 110 or 120 and stress around the getter filler 150 can be excessively increased. On the contrary, if the length (L) of the getter filler 150 exceeds 0.6 mm, the getter filler can deteriorate aesthetics of the vacuum glass panel.

In addition, if the height (h) of the getter filler 150 is less than 0.1 mm, it is difficult to form the vacuum layer (V) and the upper and lower glass panes 110, 120 can contact each other.

On the other hand, if the height (h) of the getter filler 150 exceeds 0.3 mm, the getter filler 150 has a high aspect ratio, deteriorating shape stability, and thus can be fall down upon loading of the getter filler 150, thereby deteriorating durability of the vacuum glass panel 100.

Further, if the gap (g) between the upper and lower glass panes 110, 120 becomes excessive, the vacuum glass panel 100 can be vulnerable to external impact or vibration.

Accordingly, the gap (g) between the upper and lower glass panes 110, 120 may be controlled by the height (h) of the getter filler 150.

On the other hand, a distance (d) between the getter fillers 150 may be adjusted according to thickness of the upper and lower glass panes 110, 120, and may be set to be in the range of about 10 mm to about 30 mm.

With such configuration, the vacuum glass panel 100 according to the embodiment of the invention is provided with the plurality of getter fillers having getter functions without using separate getters, thereby reducing manufacturing costs and improving durability, while improving gas adsorption efficiency through the side surfaces of the getter fillers having bosses and depressions formed thereon.

Next, a method for manufacturing a vacuum glass panel according to one embodiment of the invention will be described with reference to FIG. 4. FIG. 4 is a flowchart of a method for manufacturing a vacuum glass panel including getter fillers according to one embodiment of the present invention.

As shown in FIG. 4, in the method for manufacturing a vacuum glass panel according to one embodiment, first, an upper glass pane 110 and a lower glass pane 120 are prepared through cleaning and drying (S410).

Specifically, the upper and lower glass panes 110, 120 are subjected to cleaning and drying in a cleaning chamber (not shown), and then are moved out of the cleaning chamber through a transfer rail (not shown).

Next, the upper and lower glass panes 110, 120 are transferred into a vacuum chamber (not shown), and a sealing material is deposited along an edge of the lower glass pane 120 to form a sealing portion 130 (S420).

Here, the sealing material is prepared from, for example, a glass frit in paste form, and is deposited along the edge of the lower glass pane 120, followed by drying to form the sealing portion 130.

After the sealing portion 130 is formed, a plurality of getter fillers 150 is placed on an upper surface of the lower glass pane 120 (S430).

Specifically, the plurality of getter fillers 150 may be prepared in a hexahedral or cylindrical shape, a side surface of which is formed with bosses and depressions, as shown in FIG. 2 or FIG. 3.

Each of the getter fillers 150 is transferred by an adsorption nozzle (not shown) to be loaded on the upper surface of the lower glass pane 120 on which the sealing portion 130 is formed.

As a result, the plurality of getter fillers 150 may be disposed, for example, in a matrix arrangement, on the upper surface of the lower glass pane 120.

With the plurality of getter fillers 150 disposed thereon, the upper glass pane 110 is placed on the lower glass pane 120, followed by heating to assemble the upper and lower glass pane 110, 120 so as to face each other (S440).

With the plurality of getter fillers 150 disposed on the upper surface of the lower glass pane 120, the upper glass pane 110 is placed on the lower glass pane 120, and an overall surface of the upper glass pane 110 is heated to a temperature of, for example, 200° C. to 400° C., while evacuating the vacuum chamber, such that a vacuum layer (V) can be formed in a gap between the upper and lower glass panes.

After evacuation of the vacuum chamber to create a vacuum therein, the upper glass pane 110 may be assembled to the lower glass pane 120 to face each other by the sealing portion 130 by increasing the temperature to 450° C. or higher.

Simultaneously, heating is performed with respect to the overall surface of the upper glass pane 110, whereby the plurality of getter fillers 150 having heat resistance at 500° C. can be activated.

As such, without an activation process for separate getters, since the getter fillers 150 are activated in the course of placing and heating the upper glass pane 110 on the lower glass pane 120, it is possible to reduce cost and process time for manufacturing the vacuum glass panel 100.

Next, the present invention will be described in more detail with reference to inventive examples.

### EXAMPLES

### 1. Examples

### Preparation of Getter Fillers

### Example 1

Zr alloy-based getter fillers were prepared by punching a 0.1 mm thick sheet which is formed of a Zr alloy consisting of 84 parts by weight of Zr and 16 parts by weight of Al based on 100 parts by weight of the Zr alloy.

### Example 2

Zr alloy-based getter fillers were prepared in the same manner as in Example 1 except that a Zr alloy consisting of 70 parts by weight of Zr and 30 parts by weight of Al based on 100 parts by weight of the Zr alloy was used.

### Example 3

Zr alloy-based getter fillers were prepared in the same manner as in Example 1 except that a Zr alloy consisting of 90 parts by weight of Zr and 10 parts by weight of Al based on 100 parts by weight of the Zr alloy was used.

### Example 4

Zr alloy-based getter fillers were prepared in the same manner as in Example 1 except that a Zr alloy consisting of 76.5 parts by weight of Zr and 23.5 parts by weight of Fe based on 100 parts by weight of the Zr alloy was used.

### Example 5

Zr alloy-based getter fillers were prepared in the same manner as in Example 1 except that a Zr alloy consisting of 80 parts by weight of Zr and 20 parts by weight of Ti based on 100 parts by weight of the Zr alloy was used.

### Example 6

Zr alloy-based getter fillers were prepared in the same manner as in Example 1 except that a Zr alloy consisting of 87 parts by weight of Zr and 13 parts by weight of Ti based on 100 parts by weight of the Zr alloy was used.

### Example 7

Zr alloy-based getter fillers were prepared by punching a 0.1 mm thick sheet which is formed of a Zr alloy consisting of Zr.

### Example 8

Zr alloy-based getter fillers were prepared in the same manner as in Example 1 except that a Zr alloy consisting of 50 parts by weight of Zr and 50 parts by weight of Al based on 100 parts by weight of the Zr alloy was used.

### 2. Comparative Example

### Preparation of Vacuum Glass Panel Including Separate Spacer and Getter

A plurality of pipe-shaped distance maintenance rods each having a discharge hole was placed on a lower glass pane to be separated a distance of about 1˜30 mm from an edge of the lower glass pane, and micro-spaces were arranged at constant intervals in longitudinal and transverse directions on the lower glass pane. Here, one of the distance maintenance rods extended outside the lower glass pane so as to act as a discharge pipe.

Thereafter, an upper glass pane was placed on the lower glass pane on which the distance maintenance rods and the micro-spaces were placed, and a portion outside the distance maintenance rods, that is, a gap between the distance maintenance rods and ends of the upper and lower glass panes, was filled with a frit glass in order to seal the gap.

The frit glass filling the gap was cured through heat treatment at about 400˜850° C. for about 10 hours to assemble the upper glass pane to the lower glass pane. Next, getters formed of a Zr alloy (Zr:Fe=45:55) were inserted into the distance maintenance rod acting as a discharge pipe, followed by evacuation of the distance maintenance rod using a vacuum pump.

Thereafter, the getters formed of the Zr alloy were heated to activate the getters, and an elongated glass end of the distance maintenance rod was heated using a torch or the like to be cut and sealed, thereby preparing a vacuum glass panel.

### 3. Evaluation of Adsorption Capability and Activation Temperature

Vacuum glass panels were prepared using the getter fillers prepared in the examples. Then, the vacuum glass panels of the examples and the vacuum glass panel of the comparative example were evaluated as to getter activation temperature and gas adsorption capability immediately after activation of the getters. Results are shown in the following Table 1.

TABLE 1

| | Activation | Adsorption capability | | | | |
|---|---|---|---|---|---|---|
| | temperature | (Cu (cm) × Hg (mm)/Zr alloy or Zr (mg)) | | | | |
| | (° C.) | O₂ | N₂ | CO | CO₂ | H₂ |
| Example 1 | 500 | 0.30(25) | 0.80(500) | 0(25) | 0(25) | 0.07(25) |
| | | 1.78(400) | 1.23(800) | 0.37(500) | 0.54(500) | 13.26(350) |
| | | | | 3.50(800) | 3.00(800) | |
| Example 2 | 450 | 0.28(25) | 0.72(500) | 0(25) | 0(25) | 0.05(25) |
| | | 1.70(400) | 1.14(800) | 0.31(500) | 0.50(500) | 13.15(350) |
| | | | | 3.23(800) | 2.99(800) | |
| Example 3 | 521 | 0.41(25) | 0.91(500) | 0(25) | 0(25) | 0.11(25) |
| | | 2.17(400) | 1.47(800) | 0.39(500) | 0.58(500) | 13.39(350) |
| | | | | 3.60(800) | 3.10(800) | |
| Example 4 | 380 | 0.21(25) | 0.68(500) | 0(25) | 0(25) | 0.03(25) |
| | | 1.54(400) | 1.01(800) | 0.30(500) | 0.48(500) | 13.00(350) |
| | | | | 3.29(800) | 2.89(800) | |
| Example 5 | 430 | 0.26(25) | 0.70(500) | 0(25) | 0(25) | 0.05(25) |
| | | 1.60(400) | 1.09(800) | 0.32(500) | 0.51(500) | 13.14(350) |
| | | | | 3.25(800) | 3.01(800) | |
| Example 6 | 505 | 0.35(25) | 0.85(500) | 0(25) | 0(25) | 0.07(25) |
| | | 2.00(400) | 1.30(800) | 0.38(500) | 0.56(500) | 13.30(350) |
| | | | | 3.55(800) | 3.05(800) | |
| Example 7 | 610 | 0.38(25) | 0.95(500) | 0(25) | 0(25) | 0.09(25) |
| | | 1.99(400) | 1.46(800) | 0.43(500) | 0.57(500) | 13.33(350) |
| | | | | 3.65(800) | 3.04(800) | |
| Example 8 | 320 | 0.15(25) | 0.38(500) | 0(25) | 0(25) | 0.04(25) |
| | | 1.23(400) | 0.67(800) | 0.19(500) | 0.24(500) | 10.33(350) |
| | | | | 2.85(800) | 1.78(800) | |
| Comparative | 400 | 0.14(25) | 0.36(500) | 0(25) | 0(25) | 0.03(25) |
| Example | | 1.22(400) | 0.58(800) | 0.15(500) | 0.22(500) | 10.19(350) |
| | | | | 2.74(800) | 1.70(800) | |

(* in adsorption capability, numerals in parentheses indicate temperature. Unit is ° C. That is, the numerals indicate adsorption capability at corresponding temperature)

In Table 1, it can be seen that a higher Zr content provided better adsorption capabilities and a higher activation temperature.

Considering activation temperature and adsorption capabilities, in preparation of the getter fillers, use of Zr alloys including Al, Fe or Ti as an alloying metal was preferred to use of Zr alone. Here, in the Zr alloys, Zr was present in an amount of 70 to 90 parts by weight, and the alloying metal was present in an amount of 10 to 30 parts by weight based on 100 parts by weight.

Although the present invention has been described with reference to some embodiments in conjunction with the accompanying drawings, it should be understood that the foregoing embodiments are provided for illustration only and are not to be in any way construed as limiting the present invention

Further, it should be understood that various modifications, changes, alterations, and equivalent embodiments can be made by those skilled in the art without departing from the spirit and scope of the invention.

1. A vacuum glass panel comprising:
an upper glass pane;
a lower glass pane facing the upper glass pane;
a sealing portion formed along edges of the upper and lower glass panes and sealing a space between the upper and lower glass panes to form a vacuum layer in the space between the upper and lower glass panes; and
at least one getter filler disposed in the vacuum layer to maintain a gap having a constant thickness between the upper and lower glass panes and adsorbing gas in the vacuum layer.

2. The vacuum glass panel according to claim 1, wherein the getter filler comprises Zr as a gas adsorption material.

3. The vacuum glass panel according to claim 1, wherein the getter filler comprises a Zr alloy comprising Zr and at least one metal selected from among Al, Fe, and Ti.

4. The vacuum glass panel according to claim 3, wherein Zr is present in an amount of 70 to 90 parts by weight based on 100 parts by weight of the Zr alloy.

5. The vacuum glass panel according to claim 1, wherein the getter filler has heat resistance to maintain a shape thereof at 500° C. and a compressive strength of greater than 5000 kg/cm².

6. The vacuum glass panel according to claim 1, wherein the getter fillers have a polyhedral shape including bosses and depressions formed along a side surface thereof, and are disposed in a matrix arrangement.

7. The vacuum glass panel according to claim 1, wherein the getter filler has a length (L) of 0.4 mm to 0.6 mm and a height (h) of 0.2 mm to 0.3 mm.

8. A method for manufacturing a vacuum glass panel, comprising:
preparing an upper glass pane and a lower glass pane;
depositing a sealing material along an edge of the lower glass pane within a vacuum chamber to form a sealing portion;
placing a plurality of getter fillers on an upper surface of the lower glass pane; and
assembling the upper and lower glass panes so as to face each other by placing the upper glass pane on the lower glass pane, followed by heating.

9. The method according to claim 2, wherein the sealing material is prepared from a glass frit in paste form.

10. The method according to claim 8, wherein the placing a plurality of getter fillers comprises carrying the getter fillers using an adsorption nozzle to place the getter fillers on an upper surface of the lower glass pane.

11. The method according to claim 8, wherein the assembling the upper and lower glass panes so as to face each other comprises: evacuating the vacuum chamber to create a vacuum therein while heating an overall surface of the upper glass pane to activate the getter fillers.

12. The method according to claim 8, wherein the getter fillers have a polyhedral shape including bosses and depressions formed along a side surface thereof, and are disposed in a matrix arrangement.
